(19) United States
(12) Patent Application Publication
(10) Pub. No.: US 2020/0142973 A1
(43) Pub. Date: May 7, 2020

(54) RECOMMENDING A TARGET LOCATION WHEN RELOCATING A FILE

(71) Applicant: INTERNATIONAL BUSINESS MACHINES CORPORATION, ARMONK, NY (US)

(72) Inventors: Ya Peng Dong, BEIJING (CN); Chen Jiang, BEIJING (CN); Jian Hua Zhang, BEIJING (CN); Jing Jing Wen, BEIJING (CN); Sheng Ping Zhang, Beijing (CN); Ai Lian Mi, BEIJING (CN)

(21) Appl. No.: 16/180,061

(22) Filed: Nov. 5, 2018

(51) Int. Cl. G06F 17/30

(52) U.S. Cl. CPC G06F 17/30126; G06F 17/30082; G06F 17/30079; G06F 17/30221

(57) ABSTRACT

A computer-implemented method, computer system, and computer program product for recommending a target location for relocating a file are disclosed. In the method, a source path of a file is obtained. Then, a target starting directory in a target directory system to which the file is to be relocated is determined based on the source path. A directory model representing a subordinated directory system of the target directory system is determined. The directory model comprises at least one path starting with the target starting directory. Then, a similarity of the at least one path in the directory model with respect to the source path is determined. Next, at least one candidate path from the at least one path is recommended based on the similarity.

### BACKGROUND

The present invention relates to computer technology, and more specifically, to a computer-implemented method, computer system, and computer program product for recommending a target location when relocating a file.

File relocation is a frequently used computer operation. For example, a user may copy a file from a removable disk to a personal computer. A user may upload a file from a local computer to a cloud system. Sometimes, a user may want a target directory structure that is named the same as, or similar to, the source file path. For example, when relocating a configuration file, the target file path of the configuration file should be named the same as the source file path. When relocating a user file, the target file path of the user file may be similar to the source file path.

### SUMMARY

According to one embodiment of the present invention, there is provided a computer-implemented method for recommending a target location when relocating a file. In the method, a source file path of a file is obtained. A target starting directory in a target directory system to which the file is to be relocated is determined based on the source file path. A directory model representing a subordinated directory system of the target directory system is determined. The directory model comprises at least one file path starting with the target starting directory. A similarity of the at least one file path in the directory model with respect to the source file path is determined. At least one candidate file path from the at least one file path is recommended based on the similarity.

According to another embodiment of the present invention, there is provided a computer system comprising: one or more processors, a memory coupled to the one or more processors, and a set of computer program instructions stored in the memory and executed by the one or more processors to implement the method according to the one embodiment of the present invention as described above.

According to still another embodiment of the present invention, there is provided a computer program product. The computer program product comprises a computer readable storage medium having program instructions embodied therewith. The program instructions are executable by a processor to implement the method according to the one embodiment of the present invention as described above.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts a schematic flowchart of the method for recommending a target location when relocating a file according to an embodiment of the present disclosure.

FIG. 5 depicts a schematic flowchart of the process of determining the similarity of at least one path in the directory model with respect to the source path according to an embodiment of the present disclosure.

FIG. 6 depicts a schematic flowchart of the method for recommending a target location when relocating a file according to another embodiment of the present disclosure.

FIG. 7 illustrates an example of a target directory system.

FIG. 8 illustrates an example of a directory model of a subordinated directory system of the target directory system as shown in FIG. 7.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

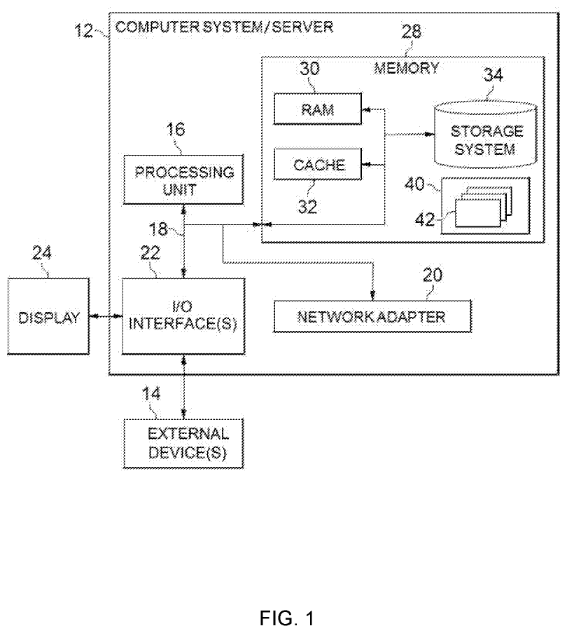

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

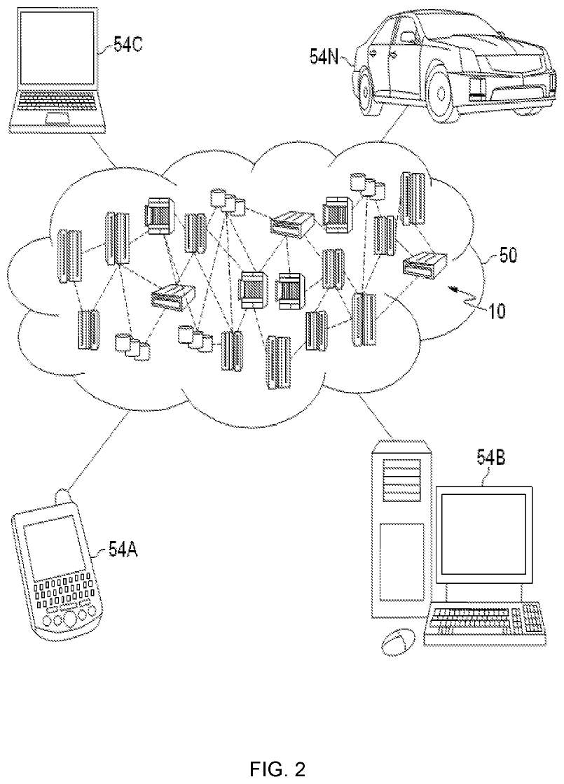

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

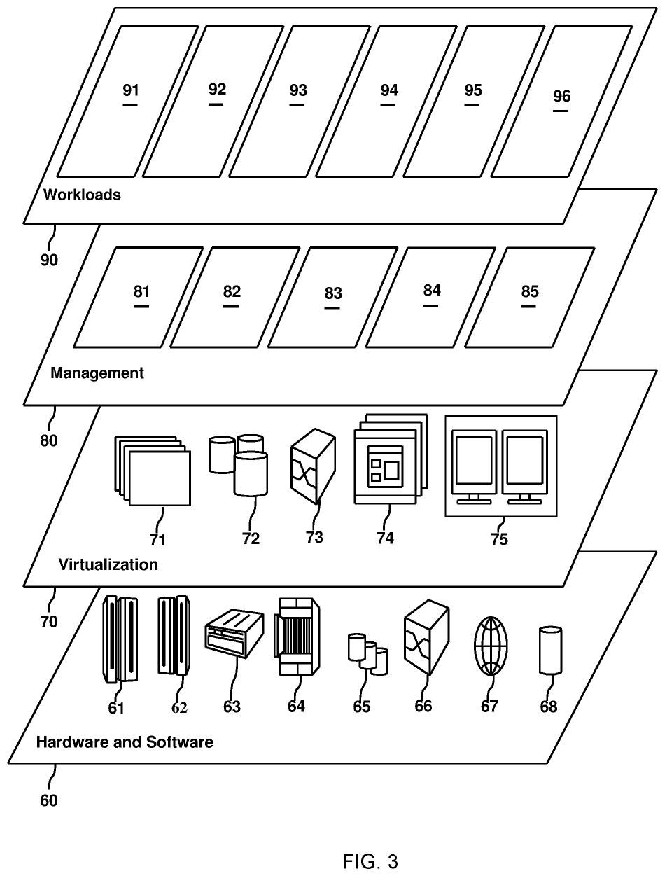

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and recommendation of file relocation 96.

Sometimes, users may need to relocate several files. It is a strenuous and time consuming work to relocate those files manually. The present disclosure provides a computer-implemented method for recommending a target location when relocating a file.

The terminology used herein is for the purpose of describing particular aspects of the disclosure only, and is not intended to limit the invention. As used herein, the singular forms “a”, “an” and “the” are intended to include the plural forms as well, unless the context clearly indicates otherwise. It should be noted that the word “comprising” does not necessarily exclude the presence of other elements or steps than those listed.

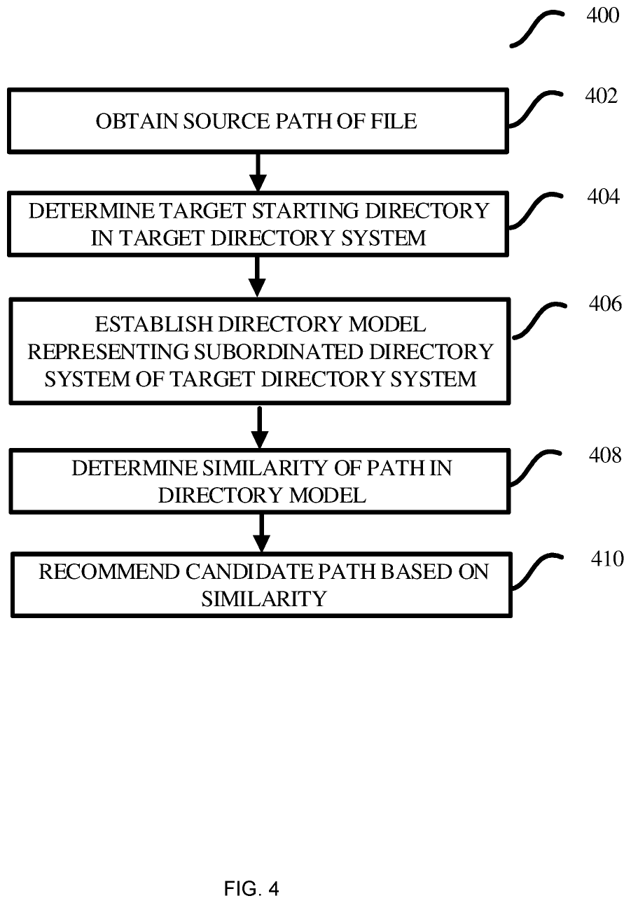

FIG. 4 shows a schematic flowchart of the method 400 for recommending a target location when relocating a file according to an embodiment of the present disclosure. In this context, relocating a file may refer to both copying a file to a new location and moving a file to a new location. A person skilled in the art will appreciate that the method 400 may be implemented by any kind of computing device, such as the computer system/server 12 as shown in FIG. 1.

As shown in FIG. 4, at block 402, the computing device obtains a source file path (also referred to as “source path” in the context) of a file. In some embodiments, the computing device may obtain a complete source file path of the file. The complete source file path comprises at least one directory. The computing device determines a special directory based on a directory type and a directory creation date and/or time of each directory in the complete source file path. Here, the term “special directory” refers to the base, or root, directory in a directory tree that terminates with the file to be relocated. The directory type may be a configuration directory, user directory, system directory, etc. The directory attribute at the operating system level may indicate what file the directory mainly includes, such as music files, image files or document files. All directories beginning with the special directory, and including those descending on the path from the special directory to the file to be relocated are included when considering the target location. Henceforth, the creation date and/or time will be referred to as creation date. The computing device then eliminates all the parent directories of the special directory from the complete source file path to obtain the source file path. In the following, the process of the method 400 is described by taking an example of relocating a configuration file “eclipse.ini”.

In an example, the complete source file path of the file “eclipse.ini” may be “C:/programs/Applications/Eclipse/Contents/eclipse/eclipse.ini”. The directory type of “C:/” is the system root directory. The directory types of “programs/”, “Applications/”, “Eclipse/”, “Contents/”, and “eclipse/” are all configuration directories. These directories, for example the directory tree starting with “Eclipse/”, may be created upon installation of an application. The particular structure of the directory tree may be automatically created by the application installation process. The proper functioning of the application may be dependent upon the particular structure, since the application must be able to locate executable files and configuration files. The directory creation date of “programs/” may be represented by a calendar date and time, but the directories “Applications/”, “Eclipse/”, “Contents/”, and “eclipse/” may share a common creation date (i.e., date and/or time) which is different from that of “programs/”. Therefore, it may be assumed that the directories of the complete file path starting from “Applications/” were created together when the file “eclipse.ini” was installed. This is because it is likely that “Applications/”, “Eclipse/”, “Contents/”, and “eclipse/” were created as part of the installation process of the Eclipse application.

The directory structure for the target location for the file “eclipse.ini” is created to reflect the directory structure of the location where it was originally created. Therefore, in this example, “Applications/” is determined as the special directory. The computing device eliminates the parent directories (i.e., “C:/programs/”) of the special directory from the complete source file path to obtain the source file path, i.e., “Applications/Eclipse/Contents/Eclipse/eclipse.ini”.

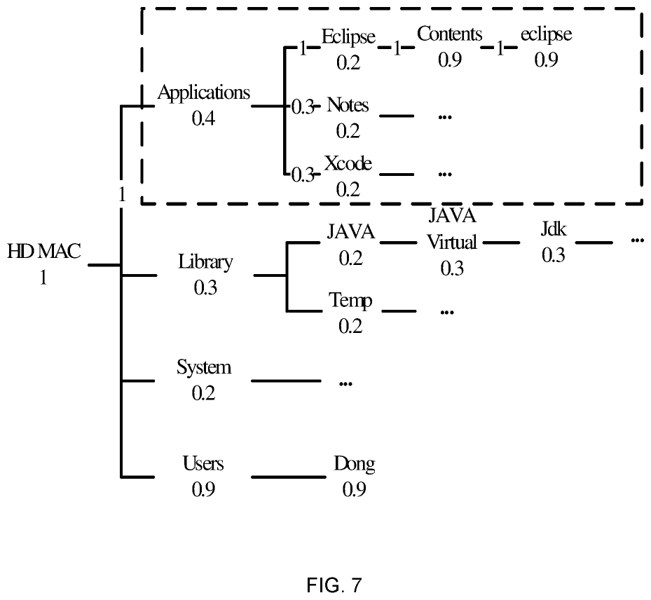

At block 404, the computing device determines a target starting directory in a target directory system to which the file is to be relocated based on the source file path. FIG. 7 shows an example of a target directory system. The file “eclipse.ini” is to be relocated to the target directory system as shown in FIG. 7.

In some embodiments, the computing device obtains a directory name of a source starting directory of the source file path. In the aforementioned example, the directory name of the source starting directory of the source file path is “Applications”. The computing device may retrieve a directory in the target directory system having the directory name “Applications”. Then, the computing device determines the directory “Applications/” in the target directory system as the target starting directory.

In some further embodiments, the computing device may obtain a directory type of the source starting directory. As mentioned above, the directory type of “Applications/” is a configuration directory. The computing device retrieves all the directories in the target directory system having the same directory type. In this example, the computing device retrieves all configuration directories.

Which directories to retrieve may be determined by accessing operating system structures that catalog directory and file attributes. Next, the computing device compares the directory name of each of the retrieved directories with the directory name of the source starting directory “Applications/”, and selects a directory having the directory name “Applications” from the retrieved directories. Comparison of directory and file names may be accomplished by known means, including string comparison functions provided by the operating system. In the example shown in FIG. 7, the directory “Users/” and “Dong/” are user directories and not configuration directories. The computing device does not compare them with the source starting directory “Applications/”. This approach may save system resources and help to find the directory “Applications/” in the target directory system faster. It should be noted that the directory structure may differ between computers and even between directory structures on the same computer. Therefore, the location of the desired directory “Applications” may not necessarily be the same on different computers.

At block 406, the computing device establishes a directory model representing a subordinated directory system of the target directory system. The directory model comprises at least one file path starting with the target starting directory. The directory model may be a decision tree, for example. In the example as shown in FIG. 7, the directory model representing the subordinated directory system is illustrated in the dashed box, which starts with the directory “Applications/”. The directory model comprises file paths: “Eclipse/Contents/eclipse/”, “Notes/ . . . ” and “Xcode/ . . . ”.

At block 408, the computing device determines a similarity of the at least one file path in the directory model with respect to the source file path.

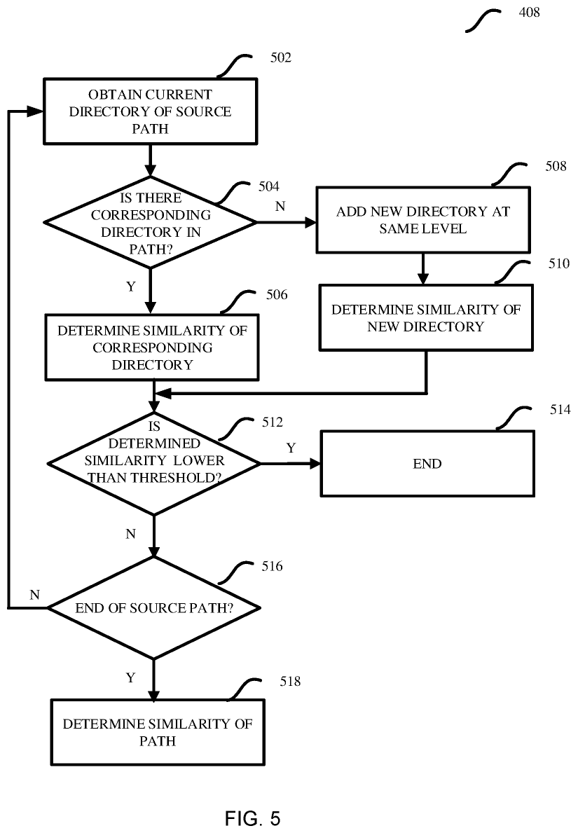

FIG. 5 illustrates a schematic flowchart of the process of determining the similarity of the at least one file path in the directory model with respect to the source file path according to an embodiment of the present disclosure. In some embodiments, for each of the at least one file path, the computing device may execute the following actions.

At block 502, the computing device may obtain a directory of the source file path as current directory. For example, the directory may be the starting directory in the source file path, or may be a secondary directory lower in the source file path.

At block 504, the computing device may determine whether there is a corresponding directory in the file path at a same level as the current directory with respect to the current directory. If there is a corresponding directory in the path (“Y” at block 504), the computing device may determine a similarity of the corresponding directory of the file path at the same level as the current directory with respect to the current directory at block 506.

If there is no corresponding directory in the file path (“N” at block 504), the computing device may add a new directory at the same level as the current directory to the file path at block 508. Then, at block 510, the computing device may determine a similarity of the new directory with respect to the current directory.

At block 512, the computing device may compare the similarity determined at block 506 or block 510 with a threshold. The threshold may be a user supplied parameter. If the determined similarity is lower than the threshold (“Y” at block 512), the computing device may end further comparison in the directory structure and not proceed to the next lower level within the current directory structure (block 514). If the determined similarity is higher than or equal to the threshold (“N” at block 512), the computing device may determine whether the current directory is the end of the source file path at block 516. If the current directory is not the end of the source file path (“N” at block 516), the computing device may obtain a secondary (the next directory lower in the directory structure) directory of the current directory as the current directory, back to block 502.

In some embodiments, if the similarity is lower than the threshold, the computing device may create one or more new directories under the corresponding directory to generate a new file path in the directory model having a same number of levels as the source file path. The computing device may determine a similarity of the respective new directories with respect to the directory of the source file path at a same level. The computing device may determine a similarity of the new file path with respect to the source file path based on the similarity of the respective directories of the new file path.

If the current directory is the end of the source file path (“Y” at block 516), it means that the similarity of each directory of the file path is higher than or equal to the threshold. The computing device may determine the similarity of the file path with respect to the source file path based on the similarity of each directory of the file path at block 518. In an example, the computing device may calculate an average similarity of the similarities of all the directories of each file path. The computing device may determine the average similarity as the similarity of each file path with respect to the source file path.

The process of determining a similarity of each file path according to the above embodiments will be described with respect to FIG. 7. In the following, the directory at the next level lower to the source starting directory (secondary directory of the source starting directory) is referred to as “source L2 directory”. The directory at the next level lower to the target starting directory (secondary directory of the target starting directory) is referred to as “target L2 directory”. The directory at the next level lower to the “source L2 directory” (secondary directory of the source L2 directory) is referred to as “source L3 directory”. The directory at the next level lower to the “target L2 directory” (secondary directory of the target L2 directory) is referred to as “target L3 directory”. The directory at the next level lower to the L3 “source L3 directory” (secondary directory of the source L3 directory) is referred to as “source L4 directory”. The directory at the next level lower to the L3 “target L3 directory” (secondary directory of the target L3 directory is referred to as “target L4 directory”.

In the example as shown in FIG. 7, the computing device determines the similarities of the target L2 directories “Eclipse/”, “Notes/” and “Xcode/” with respect to the source L2 directory “Eclipse/”, respectively. The similarity of the target L2 directory “Eclipse/” with respect to the source L2 directory “Eclipse/” is 1, which is illustrated in the path between “Application” and “Eclipse”. Here, “1” indicates the highest similarity degree. The comparison and determination of similarity may be performed using standard operating system libraries, such as string and math libraries. The similarity of the target L2 directory “Notes/” with respect to the source L2 directory “Eclipse/” is 0.3, which is illustrated in the path between “Application” and “Notes”. The similarity of the target L2 directory “Xcode/” with respect to the source L2 directory “Eclipse/” is 0.3, which is illustrated in the path between “Application” and “Xcode”.

If the similarity of the target Lx directory with respect to the source Lx directory is higher than or equal to the threshold, the computing device may determine the similarity of the target L(x+1) directory with respect to the source L(x+1) directory in the next step. If the similarity of the target Lx directory with respect to the source Lx directory is lower than the threshold, the computing device may not determine the similarity of the target L(x+1) directory with respect to the source L(x+1) directory. Here, x represents an integer higher than 1. In the case of relocating a configuration file, the threshold may be 1.

Since the similarity of the target L2 directory “Eclipse/” with respect to the source L2 directory “Eclipse/” is 1, the computing device may calculate the similarity of the target L3 directory “Contents/” with respect to the source L3 directory “Contents/”. In this way, the computing device calculates each similarity of the file path “Applications/Eclipse/Contents/eclipse/”, as shown in FIG. 7.

In some alternative embodiments, the computing device determines a similarity of each directory of each file path with respect to the corresponding directory at a same level of the source file path. The computing device determines the similarity of each file path with respect to the source file path based on the similarity of each directory of each file path. In an example, the computing device may calculate an average similarity of the similarity of each directory of each file path. The computing device may determine the average similarity as the similarity of each file path with respect to the source file path.

In some embodiments, the similarity of each directory of each file path with respect to the corresponding directory at the same level of the source file path may be determined based on at least one of a directory name, a directory creation time, a directory type, a directory attribute, a directory size and a directory utilization rate. Thus, the directory type may be configuration directory, user directory, system directory, etc. The directory attribute may indicate what file the directory mainly includes, such as music files, image files or document files. The directory utilization rate may indicate how often the directory is selected to accommodate a new file. The directory utilization rate is illustrated under the directory name of the corresponding directory as shown in FIG. 7.

Returning to FIG. 4, at block 410, the computing device recommends at least one candidate file path from the at least one file path based on the similarity. In some embodiments, the computing device may determine a predetermined number of file paths of the at least one file path with the similarities higher than the similarities of other file paths as the candidate file path. In some alternative embodiments, the computing device may determine a file path of the at least one file path with the similarity higher than or equal to the threshold as a candidate file path. If the new file path is generated, the computing device may select the candidate file path(s) from the at least one file path and the new file path. Then, the computing device may present the candidate file path(s) as a display from which the user may choose.

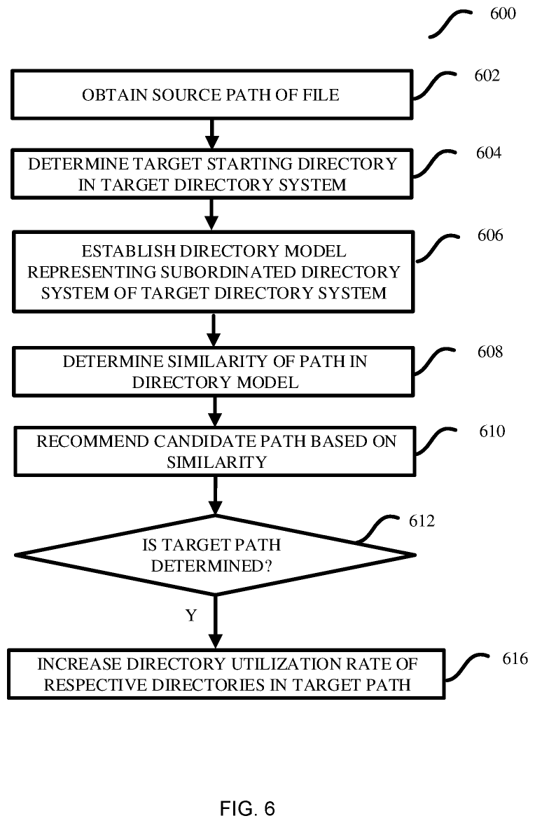

FIG. 6 depicts a schematic flowchart of the method 600 for recommending a target file location according to another embodiment of the present disclosure. The actions executed at blocks 602-610 is the same as the actions executed at blocks 402-410 in Fig.4.

At block 612, the computing device may wait for a user to select a target file path from the at least one candidate file path. The candidate file paths may be displayed to the user for selection. If the target file path is determined (selected by the user) (“Y” at block 612), the computing device may increase the directory utilization rate of each directory of the target file path at block 614. Usually, people may tend to relocate files to the same target file path at a time. The increased directory utilization rate may help to recommend the same file path. For example, when “eclipse.ini” at the source location “C:/programs/Applications/Eclipse/Contents/eclipse/” is relocated to a file path “HD MAC/Applications/Eclipse/Contents/eclipse/”, it is likely that the accompanied file “eclipse.exe” at the same source location may be relocated to the file path “HD MAC /Applications/Eclipse/Contents/eclipse/”. Utilization of a directory may be incremented for each instance it is selected by the user as the target path. Periodically, the directory utilizations may be calculated and updated by averaging the utilizations of all directories in a path. Therefore, the recommendation accuracy may be increased.

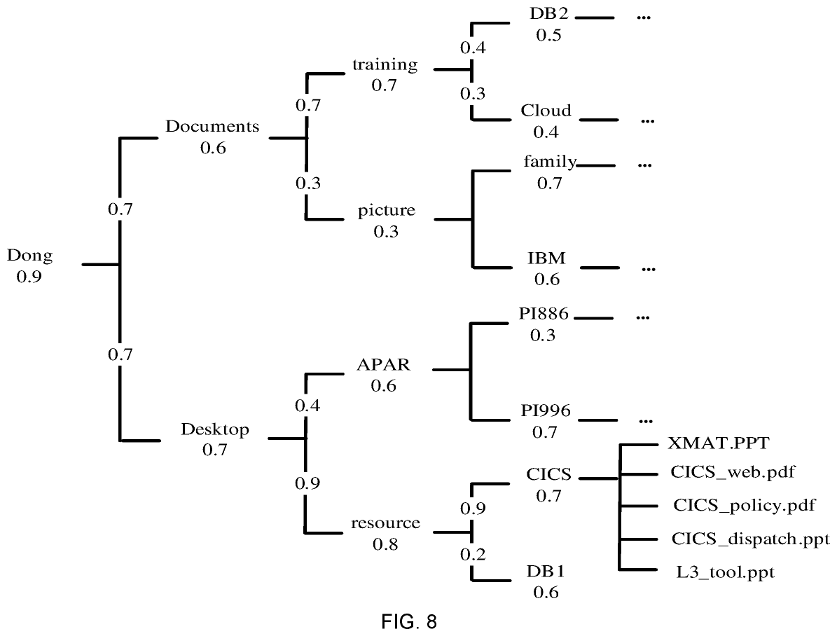

FIG. 8 shows an example of a directory model of a subordinated directory system of the target directory system as shown in FIG. 7. A subordinated directory system may be considered as all the directories in the directory path under consideration. An embodiment of recommending a target location when relocating a file is illustrated with reference to FIGS. 7 and 8. In this embodiment, the file “CICS_wait.ppt” is to be relocated. The complete file path of the file “CICS_wait.ppt” may be “C:/users/Dong/Documents/training/CICS/CICS_wait.ppt”. The process of determining the source file path of “CICS_wait.ppt” is similar to the process of determining the source file path of “eclipse.ini” as mentioned above at block 402 of FIG. 4. The source file path of “CICS_wait.ppt” is determined as “Dong/Documents/training/CICS/CICS_wait.ppt”, in this case.

The computing device determines a target starting directory “Dong/” in the target directory system as shown in FIG. 7, based on the source file path. The process of determining the target starting directory “Dong/” is similar to the process of determining the target starting directory “Applications/” as mentioned above at block 404 of FIG. 4.

Next, the computing device establishes a directory model representing a subordinated directory system of the target directory system. The directory model comprises eight file paths starting with the target starting directory “Dong/” as shown in FIG. 7. The eight file paths are represented by the directories “Dong”, “Documents”, “Desktop”, “training”, “picture”, “APAR”, “resources”, and “CICS”. Directories not having further branches, such as “DB1” are excluded.

In some embodiments, the computing device determines the similarities of the target L2 directories “Documents/” and “Desktop/” with respect to the source L2 directory “Documents/”, respectively. The similarity of the target L2 directory “Documents/” with respect to the source L2 directory “Documents/” is 0.7, which is illustrated in the path between “Dong” and “Documents”. The similarity of the target L2 directory “Desktop/” with respect to the source L2 directory “Documents/” is also 0.7, which is illustrated in the path between “Dong” and “Desktop”.

In some embodiments, if the similarity of the target Lx directory with respect to the source Lx directory is higher than or equal to a threshold, the computing device may determine the similarity of the target L(x+1) directory with respect to the source L(x+1) directory in the next step. If the similarity of the target Lx directory with respect to the source Lx directory is lower than the threshold, the computing device may not determine the similarity of the target L(x+1) directory with respect to the source L(x+1) directory. Here, x represents an integer higher than 1. In the case of relocating a user file, the threshold may be 0.5. As these two similarities of the target L2 directory “Documents/” and “Desktop/” are higher than the threshold 0.5, the computing device continues to determine the similarities of the target L3 directories “training/”, “picture/”, “APAR/” and “resource/” with respect to the source L3 directory “training/”.

As shown in FIG. 8, the similarity of the target L3 directory “picture/” with respect to the source L3 directory “training/” is 0.3, which is lower than the threshold 0.5. Thus, the computing device may not calculate the similarity at the next level along this path. In some embodiments, in this case, the computing device may create a new directory “training2/” under the directory “Documents/” and create a new directory “CICS/” under the directory “training2/” because a directory “training/” already exists. Thus, a new file path “Dong/Documents/training2/CICS/” is generated in the directory model, which has four levels as the source file path. The computing device may determine the new file path “Dong/Documents/training2/CICS” as a candidate file path.

The similarity of the target L3 directory “APAR/” with respect to the source L3 directory “training/” is 0.4, which is also lower than the threshold 0.5. Similarly, the computing device may not calculate the similarity at the next level along that path. In some embodiments, in this case, the computing device may create a new directory “training/” under the directory “Desktop/” and create a new directory “CICS/” under the directory “training/”. Thus, a new file path “Dong/Desktop/training/CICS/” is generated in the directory model, which has four levels as the source file path. The computing device may determine the new file path “Dong/Desktop/training/CICS/” as a candidate file path.

The similarity of the target L3 directory “training/” with respect to the source L3 directory “training/” is 0.7, which is higher than the threshold 0.5. Thus the computing device may calculate the similarities of the target L4 directories “DB2/” and “Cloud” with respect to the source L4 directory “CICS/”, respectively. As shown in FIG. 8, the similarities of the target L4 directories “DB2/” and “Cloud” with respect to the source L4 directory “CICS/” are both lower than 0.5. Thus, the computing device may create a new directory “CICS/” under the directory “training/”. Thus, a new file path “Dong/Documents/training/CICS/” is generated in the directory model, which has four levels as the source file path. The computing device may determine the new file path “Dong/Documents/training/CICS” as a candidate file path.

The similarity of the target L3 directory “resource/” with respect to the source L3 directory “training/” is 0.9, which is higher than the threshold 0.5. Thus the computing device may calculate the similarities of the target L4 directories “CICS/” and “DB1” with respect to the source L4 directory “CICS/”, respectively.

As shown in FIG. 8, the similarity of the target L4 directory “CICS/” with respect to the source L4 directory “CICS/” is 0.9, which is higher than the threshold 0.5. Thus the computing device may determine the file path “Dong/Desktop/resource/CICS/” as a candidate file path.

The similarities of the target L4 directories “DB1/” with respect to the source L4 directory “CICS/” is lower than 0.5. Thus, the computing device may create a new directory “CICS2/” under the directory “resource/”. Thus, a new file path “Dong/Desktop/resource/CICS2/” is generated in the directory model, which has four levels as the source file path. The computing device may determine the new file path “Dong/Desktop/resource/CICS2/” as a candidate file path.

In some embodiments, the computing device may calculate an average similarity of the similarities of all the directories of each file path. Then the computing device may determine the average similarity as the similarity of each file path with respect to the source file path. For example, the average similarity of the file path “Dong/Desktop/resource/CICS/” is (1+0.7+0.9+0.9)/4=0.875. In this case, the similarity of the file path “Dong/Desktop/resource/CICS/” is 0.875.

Alternative, the computing device may determine a similarity of each directory of each file path in the directory model with respect to the corresponding directory at a same level of the source file path. In the example as shown in FIG. 8, the computing device may determine a similarity of each directory of the eight file paths in the directory model. Then, the computing device may determine whether each similarity of a file path is higher than or equal to 0.5. If yes, the computing device may determine the file path as a candidate file path.

The computing device may calculate the average similarity of each candidate file path with respect to the source file path. The average similarity of a candidate file path is used to rank the candidate file path.

In some embodiments, the computing device may recommend a predetermined number of candidate file paths for a user file. For example, the computing device may recommend five candidate file paths for a user file. If there are more than five possible file paths in which each directory has a similarity higher than 0.5, the computing device may recommend the five possible file paths ranked on the top as the candidate file paths. Then, the computing device may present the five candidate file paths to the user.

If the user chooses to relocate the file “CICS_wait.ppt” to the file path “Dong/Desktop/resource/CICS/”, the computing device may increase the directory utilization rates of the directories “Dong/”, “Desktop/”, “resource/” and “CICS/” in the directory model. Since the directory utilization rate reflects the user habits, the directory model functions as a customized directory model.

As described above, the method for recommending a target location when relocating a file provides one or more candidate file path to which the file can be relocated.

Another embodiment of the present disclosure provides a computer system for recommending a target location when relocating a file. The computer system may comprise one or more processors, a memory coupled to at least one of the processors, and a set of computer program instructions stored in the memory. The set of computer program instructions are executed by at least one of the processors to obtain a source file path of a file; determine a target starting directory in a target directory system to which the file is to be relocated based on the source file path; establish a directory model representing a subordinated directory system of the target directory system, wherein the directory model comprises at least one file path starting with the target starting directory; determine a similarity of the at least one file path in the directory model with respect to the source file path; and recommend at least one candidate file path from the at least one file path based on the similarity.

Similarly, under the same inventive concept, another embodiment of the present disclosure can provide a computer program product. The computer program product comprises a computer readable storage medium having program instructions embodied therewith. The program instructions are executable by a processor to obtain a source file path of a file; determine a target starting directory in a target directory system to which the file is to be relocated based on the source file path; establish a directory model representing a subordinated directory system of the target directory system, wherein the directory model comprises at least one file path starting with the target starting directory; determine a similarity of the at least one file path in the directory model with respect to the source file path; and recommend at least one candidate file path from the at least one file path based on the similarity.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining, by one or more processors, a source path of a file;
determining, by one or more processors, a target starting directory in a target directory system to which the file is to be relocated based on the source path;
establishing, by one or more processors, a directory model representing a subordinated directory system of the target directory system, wherein the directory model comprises at least one path starting with the target starting directory;
determining, by one or more processors, a similarity of the at least one path in the directory model with respect to the source path; and
recommending, by one or more processors, at least one candidate path from the at least one path based on the similarity.

2. The method according to claim 1, wherein the obtaining the source path of the file comprises:
obtaining, by one or more processors, a complete path of the file, wherein the complete path comprises at least one directory; and
eliminating, by one or more processors, one or more parent directories of a special directory from the complete path to obtain the source path;
wherein the special directory is determined based on a directory type and a directory creation time of the at least one directory of the complete path.

3. The method according to claim 1, wherein the determining the target starting directory in the target directory system to which the file is to be relocated based on the source path comprises:
obtaining, by one or more processors, a directory name of a source starting directory of the source path; and
determining, by one or more processors, a directory in the target directory system having the same directory name as the target starting directory.

4. The method according to claim 3, wherein the determining the directory in the target directory system having the same directory name as the target starting directory comprises:
obtaining, by one or more processors, a directory type of the source starting directory;
retrieving, by one or more processors, at least one directory in the target directory system having the same directory type; and
selecting, by one or more processors, a directory having the same directory name from the retrieved at least one directory.

5. The method according to claim 1, wherein the determining the similarity of the at least one path in the directory model with respect to the source path comprises:
for each of the at least one path in the directory model,
for each directory of the source path used as current directory,
in response to there is a corresponding directory in the path,
determining, by one or more processors, a similarity of the corresponding directory of the path at a same level as the current directory with respect to the current directory;
in response to no corresponding directory in the path,
adding, by one or more processors, a new directory at the same level as the current directory to the path; and
determining, by one or more processors, a similarity of the new directory with respect to the current directory;
in response to the determined similarity being lower than a threshold, stopping determining a similarity of a subsequent directory of the corresponding directory with respect to a subsequent directory of the current directory by one or more processors; and
in response to the determined similarity being higher than or equal to the threshold, determining whether there is a corresponding directory in the path with respect to a subsequent directory of the current directory by one or more processors;
in response to the similarity of each directory of the path being higher than or equal to the threshold,
determining, by one or more processors, the similarity of the path with respect to the source path based on the similarity of each directory of the path.

6. The method according to claim 5, wherein the similarity of the directory of the path with respect to the corresponding directory at the same level of the source path is determined based on at least one of a directory name, a directory creation time, a directory type, a directory attribute, a directory size and a directory utilization rate.

7. The method according to claim 6 further comprising:
increasing, in response to a target path of the file being determined from the at least one candidate path, the directory utilization rate of the respective directories of the target path by one or more processors.

8. The method according to claim 5, wherein the recommending at least one candidate path from the at least one path based on the similarity comprises:
determining, by one or more processors, a predetermined number of path of the at least one path as the candidate path based on the similarity; and
presenting, by one or more processors, the candidate path.

9. The method according to claim 5, wherein the determining the similarity of the at least one path in the directory model with respect to the source path further comprises:
in response to the similarity being lower than the threshold,
creating, by one or more processors, one or more new directories under the corresponding directory to generate a new path in the directory model having a same number of levels as the source path;
determining, by one or more processors, a similarity of the respective new directories with respect to the directory of the source path at a same level; and
determining, by one or more processors, a similarity of the new path with respect to the source path based on the similarity of the respective directories of the new path.

10. The method according to claim 9, wherein the candidate path is selected from the at least one path and the new path.

11. The method according to claim 1, wherein the determining the similarity of the at least one path in the directory model with respect to the source path comprises:
determining, by one or more processors, a similarity of the respective directories of the at least one path with respect to the corresponding directory at a same level of the source path; and
determining, by one or more processors, the similarity of the at least one path with respect to the source path based on the similarity of the respective directories of the at least one path.

12. A computer system comprising:
one or more processors;
a memory coupled to the one or more processors; and
a set of computer program instructions stored in the memory and executed by the one or more processors to implement a method comprising:
obtaining a source path of a file;
determining a target starting directory in a target directory system to which the file is to be relocated based on the source path;
establishing a directory model representing a subordinated directory system of the target directory system, wherein the directory model comprises at least one path starting with the target starting directory;
determining a similarity of the at least one path in the directory model with respect to the source path; and
recommending at least one candidate path from the at least one path based on the similarity.

13. The computer system according to claim 12, wherein the obtaining the source path of the file comprises:
obtaining a complete path of the file, wherein the complete path comprises at least one directory; and
eliminating one or more parent directories of a special directory from the complete path to obtain the source path;
wherein the special directory is determined based on a directory type and a directory creation time of the at least one directory of the complete path.

14. The computer system according to claim 12, wherein the determining the target starting directory in the target directory system to which the file is to be relocated based on the source path comprises:
obtaining a directory name of a source starting directory of the source path; and
determining a directory in the target directory system having the same directory name as the target starting directory.

15. The computer system according to claim 14, wherein the determining the directory in the target directory system having the same directory name as the target starting directory comprises:
obtaining a directory type of the source starting directory;
retrieving at least one directory in the target directory system having the same directory type; and
selecting a directory having the same directory name from the retrieved at least one directory.

16. The computer system according to claim 12, wherein the determining the similarity of the at least one path in the directory model with respect to the source path comprises:
for each of the at least one path in the directory model,
for each directory of the source path used as current directory,
determining a similarity of the corresponding directory of the path at a same level as the current directory with respect to the current directory;
in response to the similarity being lower than a threshold, stopping determining a similarity of a subsequent directory of the corresponding directory with respect to a subsequent directory of the current directory by one or more processors,
in response to no corresponding directory in the path,
adding a new directory at the same level as the current directory to the path; and
determining a similarity of the new directory with respect to the current directory; and
in response to the similarity of the respective directories of the path being higher than or equal to the threshold,
determining the similarity of the path with respect to the source path based on the similarity of the respective directories of the path.

17. The computer system according to claim 16, wherein the similarity of the directory of the path with respect to the corresponding directory at the same level of the source path is determined based on at least one of a directory name, a directory creation time, a directory type, a directory attribute, a directory size and a directory utilization rate.

18. The computer system according to claim 16, wherein the recommending at least one candidate path from the at least one path based on the similarity comprises:
determining a predetermined number of path of the at least one path as the candidate path based on the similarity; and
presenting the candidate path.

19. The computer system according to claim 16, wherein the determining the similarity of the at least one path in the directory model with respect to the source path further comprises:
in response to the similarity being lower than the threshold,
creating one or more new directories under the corresponding directory to generate a new path in the directory model having a same number of levels as the source path;
determining a similarity of the respective new directories with respect to the directory of the source path at a same level; and
determining a similarity of the new path with respect to the source path based on the similarity of the respective directories of the new path.

20. A computer program product implemented in a storage system, wherein the computer program product comprises a computer readable storage medium having program instructions embodied therewith, wherein the program instructions are executable by processor to implement a method comprising:
obtaining a source path of a file;
determining a target starting directory in a target directory system to which the is to be relocated based on the source path;
establishing a directory model representing a subordinated directory system of the target directory system, wherein the directory model comprises at least one path starting with the target starting directory;
determining a similarity of the at least one path in the directory model with respect to the source path; and
recommending at least one candidate path from the at least one path based on the similarity.
